(19) United States
(12) Patent Application Publication
(10) Pub. No.: US 2010/0154573 A1
(43) Pub. Date: Jun. 24, 2010

(54) TWIN LAYSHAFT TRANSMISSION

(75) Inventors: Nicholas Jackson, Warwickshire (GB); John Stanton, Warwickshire (GB)

Correspondence Address: DORITY & MANNING, P.A., POST OFFICE BOX 1449, GREENVILLE, SC, 29602-1449, US

(73) Assignee: RICARDO UK LTD., West Sussex (GB)

(21) Appl. No.: 12/063,481

(22) PCT Filed: Aug. 15, 2006
(86) PCT No.: PCT/GB2006/003048

§ 371 Date: May 1, 2008

(30) Foreign Application Priority Data
Aug. 15, 2005 (GB) 0516726.7

(51) Int. Cl. F16H 3/093

(52) U.S. Cl. 74/331

(57) ABSTRACT

Various configurations of twin layshaft gear transmission are disclosed, typically having a large degree of common parts between single and dual clutch variants. In one embodiment reverse ratio is provided via an independent compound idler and is driven from a driving gear also associated with a forward speed ratio.

### CROSS-REFERENCE TO RELATED APPLICATIONS

This application claims priority to Great Britain Application No. 0516726.7 filed Aug. 15, 2005 and International Application Serial No. PCT/GB2006/003048 filed Aug. 15, 2006.

### TECHNICAL FIELD

This invention relates to a multi-speed twin layshaft gear transmission suitable for use in a motor vehicle.

### BACKGROUND

Conventionally a gear transmission with multiple forward ratios has co-axial input and output shafts, and a single layshaft. Pairs of gears between the layshaft and input/output shafts provide different speed ratios, and are selectable one at a time by the vehicle driver. Multi-speed transmission of this kind are relatively long because the gear pairs lie side by side along the transmission drive axis.

For reasons of fuel economy, the number of forward speeds has increased in recent years, so that six-speed transmissions are now favoured. Such transmissions allow the vehicle engine to provide adequate acceleration whilst being economical and quiet at cruising speed. However it is difficult to fit a single layshaft six speed transmission into a front wheel drive vehicle with transverse engine/driveline, especially a small vehicle, because the engine/transmission unit is long compared with the available space between the driving wheels.

Twin layshaft transmissions offer the possibility of reducing transmission length, at the cost of increasing transmission width, and are one potential solution to this problem.

Another problem faced by vehicle and transmissions engineers is that of providing both manual and automatic variants. Generally speaking these variants have traditionally been very different, but it would be advantageous for both to have a very similar size and shape so as to avoid unnecessary compromise in vehicle design. So called twin-clutch transmissions offer such a possibility since the internal arrangement of both manual and automatic variants can be very similar. Both manual and sequential automatic variants can be offered with almost the same external envelope, and the same number of ratios.

In order to produce manual and automatic versions at minimum cost, each variant should have the maximum number of common parts.

### BRIEF SUMMARY

According to a first aspect of the present invention there is provided a multi-speed gear transmission being one of two variants and comprising an input, an output and two layshafts, pairs of gears being provided between the input and layshafts for selectable drive on demand, and each layshaft being in driving engagement with said output, wherein the transmission provides six selectable gear pairs providing six spaced forward ratios, the input comprises one of

A: a drive shaft common to all gear pairs, and

B: dual co-axial drive shafts, one associated with the gear pairs of the odd ratios and one associated with the gear pairs of the even ratios,

wherein for both A and B, five of said gear pairs are associated with the same layshafts, and speed ratios 3, 5, or 4, 6 are at the outboard end of said transmission.

Such an arrangement allows the input, output and two layshafts to be on the same centres for both A and B variants. Furthermore the said five gear pairs are common to both A and B variants. Preferably the even ratios of B are associated with an outer drive shaft.

In this specification, common parts are proposed for two transmission variants. By ‘common’ we mean that the respective finished parts are functionally identical and substantially identical in shape save for very minor and inconsequential features. Thus shafts and gears are typically identical in material, size and form. Selector hub components, shafts and forks may also comprise substantially identical finished parts.

In one preferred embodiment second speed ratio is associated with one layshaft for variant A, and a different layshaft for variant B.

Typically the layshaft axes will be at a different distance from the input axis; accordingly in the preferred embodiment the second speed ratio is identical in both variants, but the associated gear pairs are of different diameter.

Preferably the layshafts are substantially identical for variants A and B. Thus in the preferred embodiment each layshaft defines four gear locations to be associated with respective gear pairs. Said locations are in use associated with freely rotatable driven gears engageable on demand with respective layshafts. In the preferred embodiment said locations are identical on both layshafts so that in use the locations lie in four successive transverse planes. The locations are preferably paired and the transmission further comprises a plurality of selector hubs, one each associated with each location pair. Preferably the hubs lie in two successive transverse planes. Typically a selector hub will be axially reciprocal about a respective layshaft axis to engage one of two driven gears associated therewith.

In the preferred embodiment, the gear pairs are ordered differently on the respective layshafts for variants A and B. Thus in variant A first layshaft is associated with speed ratios 1, 2, 5, 6, whereas in variant B, the same layshaft is associated with speed ratios 1,5,6.

In the preferred embodiment, the endmost speed ratios for both variants are 3, 5.

Preferably the layshafts/output connection is axially at the input side of the transmission.

The transmission of the invention has common driving gears for a plurality of said gear pairs. Thus in both variants common driving gears are provided for ratios 4, 6 and 3, 5.

In the preferred embodiment selector rails are provided for selector forks, one each of which is associated with a respective selector hub. The selector shafts and forks are identical for both A and B variants and have axes in the same transverse positions with respect to the input axis. Preferably the selector hubs are substantially identical.

Preferably a reverse ratio is provided and comprising an input gear associated with a forward ratio, and sequential driven gears one on each layshaft, wherein the intermediate gear is an idler.

A transmission according to the invention provides six forward and one reverse ratio from gear trains arranged in four successive transverse planes along said input axis. Furthermore four selector hubs can be arranged in two transverse planes between the first and second, and third and fourth gear planes.

In an alternative aspect of the invention a twin layshaft transmission has a reverse ratio provided via a compound gear comprising two gear profiles side by side for rotation together. Such an arrangement preferably utilises a common input gear, such as the input gear of first or second ratio, and an output gear associated with one of said layshafts and selectable via a single acting selector hub. The compound gear is provided on an additional layshaft and provides for variation in speed ratio according to the ratio with both the input gear and the output gear. In the preferred embodiment the compound gear comprises gear profiles of different diameter. Other advantages of commonality between single and twin layshaft transmissions are preserved.

Such an arrangement allows the reverse ratio output gear to be in a different plane from the forward speed ratios, which may confer advantages in space utilization.

In a preferred embodiment, reverse ratio is driven from first speed input gear via an independent layshaft and compound gear thereon, said first speed input gear being immediately adjacent the input end of said input shaft, and the plane of reverse ratio output gear being distal thereof.

Preferably speed ratios 3, 4, 5, 6 are provided in two gear planes distal with respect to the input end of said input shaft from gear planes associated with speed ratios 1,2. Thus four gear planes are provided for forward ratios, and a fifth gear plane for the output gear of reverse gear train, the input gears thereof lying in one of the planes associated with a forward speed ratio. T he reverse output gear plane preferably lies substantially in the neutral plane of the selector hub of two forward speed ratios, preferably the forward ratios associated with first and second speeds.

Other features of the invention will be apparent from the following description of preferred embodiments shown by way of example only in the accompanying drawings in which:

### BRIEF DESCRIPTION OF THE DRAWINGS

FIG. 1 is a developed schematic plan of a six speed, twin layshaft single clutch transmission.

FIG. 2 is a representative end view showing the true spatial relationship of shafts.

FIG. 3 corresponds to FIG. 1 and shows a six speed; twin layshaft dual clutch transmission.

FIG. 4 corresponds to FIG. 2, but illustrates the true arrangement of shafts of FIG. 3.

FIG. 5 corresponds to FIG. 1 and shows reverse ratio via independent layshaft.

FIG. 6 corresponds to FIG. 5 and shows reverse ratio via wide first ratio input gear.

FIG. 7 is an alternative embodiment according to a second aspect of the invention and shows a single clutch transmission with compound reverse idler.

### DETAILED DESCRIPTION OF EMBODIMENTS

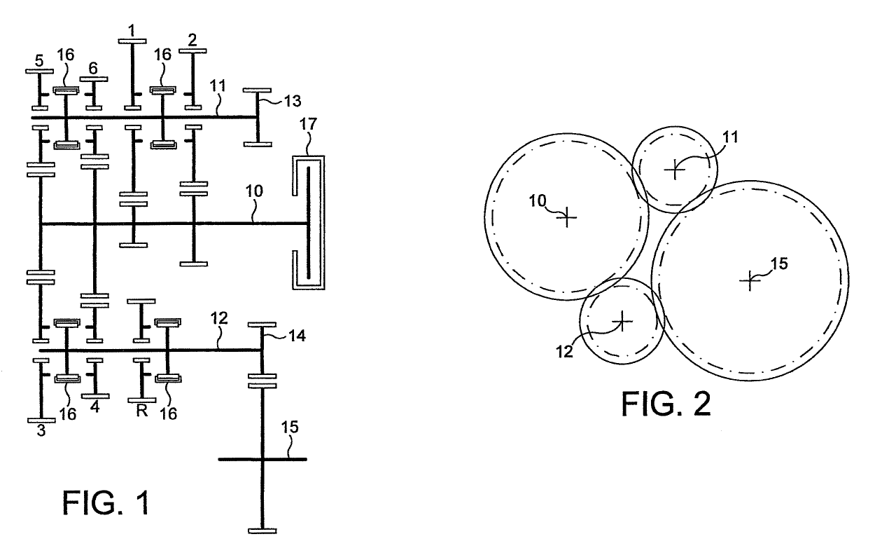

With reference to the drawings FIGS. 1 and 2 illustrates a single clutch manual transmission having six forward speeds and reverse. An input shaft 10 and two layshafts 11, 12 are provided with pairs of gears therebetween. Each layshaft 11, 12 has an output gear 13, 14 coupled to a common final drive gear 15, as best illustrated in FIG. 2.

Six forward speeds are provided by respective gear pairs and identified by the numbers ‘1-6’. Each pair comprises a driving wheel of the input shaft 10, and a respective driven wheel rotatable on one or other layshaft 11,12, and connectable thereto by conventional selector hubs 16. The hubs 16 are shifted, from the neutral position indicated in FIG. 1, either to the left or right to couple a respective gear wheel for rotation with the layshaft which is co-axial therewith.

Reverse gear (‘R’) is provided via two driven gears, one being provided on each layshaft, and the intermediate gear acting as an idler; in this way a separate layshaft for reverse is avoided.

The physical diameters of the gears illustrated in the drawings is representative;

the skilled man will select diameters according to the ratios required, and to avoid clashing of neighbouring gears. Likewise the respective centres of the shafts, and axial spacing of the gears thereon will be determined according to the design requirements.

In use the transmission of FIG. 1 is operated conventionally in conjunction with the clutch 17. A selector mechanism not shown, allows selector hubs 16 to be engaged one at a time on demand to define a torque transmission path from engine to road wheels. The speed ratios can be selected in any order.

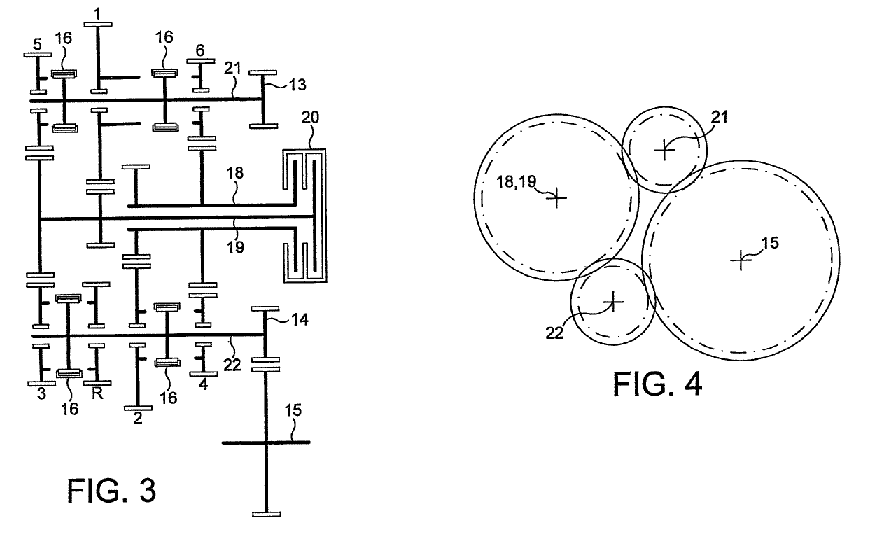

FIGS. 3 and 4 show a corresponding twin clutch transmission having co-axial input shafts 18,19 driven via one or other of a dual clutch pack 20. As is apparent from FIG. 4, the spatial relationship of the layshafts 21, 22 is identical to that of FIG. 2, which means that the transmission envelope can be very similar. The gear pairs are differently arranged, as shown by the references ‘1-6’ and ‘R’.

The transmission of FIG. 3 is operated by pre-selecting the next desired ratio (which must be associated with the non-driven input shaft) and disengaging one clutch as the other is engaged. Ratio changes are normally under automatic or semi-automatic control. In practice such transmissions tend to be sequential, though several ratios may be missed if desired; for example the transmission may be permitted to change down from 6th speed to 3rd speed if conditions are suitable.

An important feature of the invention is that the transmissions of FIGS. 1 and 3 have great commonality of components notwithstanding that in FIG. 3 the ‘odd’ and ‘even’ ratios must be grouped so as to be associated with the respective input shaft. Thus the following parts are common:
input gears for 3rd/5th and 4th/6th ratios
all layshaft gears except 2nd
both layshafts
final drive gears (including differential)
selector forks, fork rails, and much of the selector mechanism
selector hub position on the layshafts
selector hub assemblies
minor components such as bearing and seals

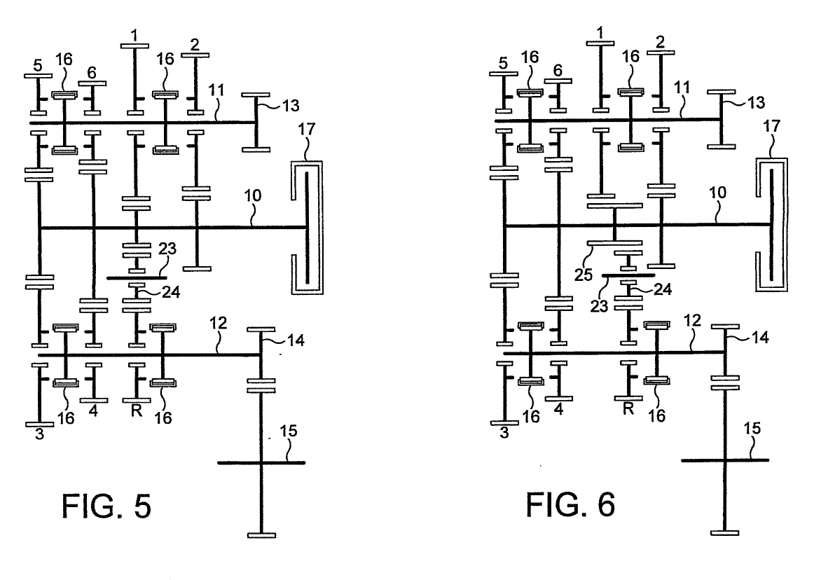

FIG. 5 illustrates a variant of FIG. 1 in which reverse ratio is provided via an additional layshaft 23 on which is supported an idler gear 24. This reverse ratio no longer uses first output gear as an idler, and this arrangement may reduce the required torque capacity thereof. The same arrangement is possible in a similar modification of the transmission of FIG. 3.

An additional advantage of FIG. 5 is that the reverse ratio is no longer dependent on first ratio, and thus greater design freedom is available at the cost of an additional layshaft and idler gear.

It will also be appreciated that the arrangements of FIGS. 1, 3 and 5 are susceptible of further modification to permit reverse ratio to be driven from the second speed input gear rather than the first speed input gear. The alternative arrangement gives additional possibilities for reverse ratio, depending on the physical constraints and the required gears shift pattern.

Yet a further potential variation is to allow forward and reverse gear ratios of FIG. 1 in parallel planes, but to be driven by a common, wide, input gear. FIG. 6 illustrates such a possibility by variation of FIG. 5; the first input gear 25 drives reverse via an idler 24, but in a plane parallel to the first speed output gear. Such an arrangement is of course also possible using a wide second speed input gear.

A further option, not illustrated, is to provide two input gears side by side for reverse and first speed ratios. In effect the wide gear 25 of FIG. 6 is divided to provide a separate torque path for each of first and reverse ratios. Such an arrangement allows further independence of ratio choice.

In yet a further alternative, reverse gear sleeve of FIG. 1 is also displaceable to the right, and is thus double acting. In the rightwards position the layshaft 12 is arranged to be locked to the transmission casing, thus giving an anti-rotation feature equivalent to the PARK position in a conventional automatic vehicle transmission. As is well understood, such a feature can replace or compliment a conventional parking brake.

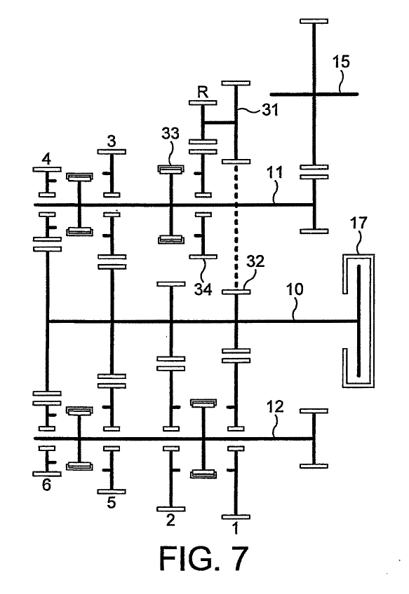

FIG. 7 illustrates an alternative embodiment in which reverse ratio is provided via an independent layshaft and compound gear 31 which comprises two gear profiles side by side and rotatable in unison. Both first and reverse ratios are driven from a common input gear 32 which is immediately adjacent the clutch 17. Reverse selector hub 33 engages a loose gear 34, which is in mesh with the compound gears 31, with an output shaft 11. Other forward speed ratios are provided as indicated with ratios 4,6 outermost (i.e. at the opposite end to the clutch).

It will be appreciated that by changing the gear pair positions of the embodiment of FIG. 7, the speed ratios 1, 3, 5, R may be driven from one input shaft, and the ratios 2, 4, 6 from a co-axial input shaft, thus providing a dual input transmission of the kind illustrated in FIG. 3. Furthermore the ratios 3, 5 may be end most.

Although this description is made with reference to a transmission for a vehicle, it will be appreciated that the arrangements described herein are suitable for other kinds of installation where different speed ratios are required on demand.

1. A transmission according to claim 11, wherein reverse ratio is provided between the input and one of said layshafts via an idler journalled on a third layshaft, said idler comprising a compound gear having side by side gear profiles for rotation in unison.

2. A transmission according to claim 1 wherein said side by side gear profiles are of different diameter.

3. A transmission according to claim 2 wherein the gear profile of the largest diameter is at the input side of the input shaft assembly.

4. A transmission according to claim 1, wherein a driving gear for said idler is provided on an input shaft, and said driving gear also provides direct drive to one of said twin layshafts for a forward speed ratio.

5. A transmission according to claim 4 wherein said forward speed ratio is in the lowest forward speed ratio.

6. A transmission according to claim 11, wherein reverse speed ratio has an input plane and an output plane, the input and output planes being parallel, and the input plane being immediately adjacent the input side of the input.

7. A transmission according to claim 11, wherein an input shaft assembly includes four input gears fast for rotation therewith, and wherein two of said input gears are adapted for drive to one or the other of said twin layshafts.

8. A transmission according to claim 11, wherein reverse output gear comprises a loose wheel journalled on one of said twin layshafts and connectable thereto via an axially movable selector hub, wherein said hub is substantially in the same plane as a forward speed ratio associated with the other of said twin layshafts.

9. A transmission according to claim 11, wherein forward ratios 3, 4 are associated with one of said twin layshafts, and forward ratios 1, 2, 5, 6 are associated with the other of said twin layshafts.

10. A transmission according to claim 9 wherein reverse ratio R is associated with said one of said twin layshafts.

11. A multi-speed gear transmission being one of two variants, and comprising an input, an output and two layshafts, pairs of gears being provided between the input and layshafts for selectable drive on demand, and each layshaft being in driving engagement with said output, wherein the transmission provides six selectable gear pairs providing six spaced forward ratios (1,2,3,4,5,6), the input comprises one of
A: a drive shaft common to all gear pairs, and
B: dual co-axial drive shafts, one associated with the gear pairs of the odd ratios (1,3,5) and one associated with the gear pairs of the even ratios (2,4,6),
wherein for both A and B, five of said gear pairs are associated with the same layshafts, and speed ratios 3,5 or 4,6 are at the outboard end of said transmission.
